(19) United States
(12) Patent Application Publication
(10) Pub. No.: US 2013/0332422 A1
(43) Pub. Date: Dec. 12, 2013

(54) Defining Content Retention Rules Using a Domain-Specific Language

(71) Applicant: INTERNATIONAL BUSINESS MACHINES CORPORATION, Armonk, NY (US)

(72) Inventors: Edward L. Bader, Los Angeles, CA (US); Jean-Marc Costecalde, Irvine, CA (US); Chi M. Nguyen, Irvine, CA (US)

(21) Appl. No.: 13/875,471

(22) Filed: May 2, 2013

Related U.S. Application Data
(63) Continuation of application No. 13/489,789, filed on Jun. 6, 2012.

(51) Int. Cl. G06F 17/30

(52) U.S. Cl. CPC G06F 17/30289
USPC 707/662

(57) ABSTRACT

A method, a system and a computer program product create a retention schedule for content within a content repository. A rule is obtained in a domain-specific language specifying content for retention, a retention time period, and a task for performance upon expiration of the retention time period, and the rule is processed to create the retention schedule. The processing of the rule includes mapping the specified content to content within the content repository, creating an action corresponding to the specified task for the content repository, and creating the retention schedule linking the mapped content and created action for the specified retention time period.

### CROSS REFERENCE TO RELATED APPLICATIONS

The present application claims priority to U.S. Nonprovisional Application No. 13/489,789, filed on 6 Jun. 2012 and entitled “Defining Content Retention Rules Using a Domain-Specific Language,” the disclosure of which is incorporated herein by reference in its entirety.

### BACKGROUND

1. Technical Field

Present invention embodiments relate to content management systems and the retention of records within such systems.

2. Discussion of Related Art

In content management systems, such as records management systems, retention schedules can be created to manage content within records based upon rules associated with such content. The rules are typically expressed in a natural language so as to be identified by a system administrator or other user. Some examples of natural language rules associated with records might be “retain e-mail for 3 years” or “employment records must be retained for 5 years after employee separation”.

Current records management applications can provide rules within a web application or GUI (graphical user interface) or, alternatively, through one or more programming APIs (application programming interfaces). However, this requires records administrators to create retention schedules by translating mentally between descriptions in the retention rules and actions in the user interface or function calls in an API. This mental translation and mapping of requirements into concrete rules leaves room for ambiguity and can result in records not meeting expectations or legal requirements.

### BRIEF SUMMARY

Embodiments of the present invention include a method, a system and a computer program product for creating a retention schedule for content within a content repository, which comprises obtaining a rule in a domain-specific language specifying content for retention, a retention time period, and a task for performance upon expiration of the retention time period, and processing the rule to create the retention schedule. The processing of the rule includes mapping the specified content to content within the content repository, creating an action corresponding to the specified task for the content repository, and creating the retention schedule linking the mapped content and created action for the specified retention time period.

### BRIEF DESCRIPTION OF THE SEVERAL VIEWS OF THE DRAWINGS

FIG. 1 is a diagrammatic illustration of a computing environment for an embodiment of the present invention.

FIG. 2 is a schematic diagram of an example records management system that generates and/or implements a domain-specific language in relation to retention of records and content according to an embodiment of the present invention.

FIG. 3 is a procedural flow chart illustrating an example manner in which a retention schedule is created and implemented for content within a content repository according to an embodiment of the present invention.

### DETAILED DESCRIPTION

Present invention embodiments pertain to methods and corresponding systems and computer program products for managing content within a content repository. In particular, a retention schedule is created to manage content, in which the retention schedule comprises a rule in a domain-specific language that specifies types of content for retention, one or more time periods for retention of such content, and what types of performance tasks are required in relation to such content when the retention time period has expired. The rule is processed so as to map specified content to content within the content repository. In addition, an action is created for the content repository corresponding to one or more performance tasks defined by the rule, and a retention schedule is also created that links the mapped content with the created action for the specified retention time period.

The content repository can be of any suitable one or more types that stores any suitable one or more types of content. Examples of content repositories include content management systems (e.g., enterprise content management systems) such as database management systems (DBMS) that store content in one or more databases and/or other data sources. The content can be textual content (e.g., documents, records, etc.), image content (e.g., still images, video content, etc.) and/or any other types and forms of data. The content can be organized and stored within the content management systems in a categorized or indexed format (e.g., with one or more taxonomies that define the organizational structure of the content within the data sources of the content management system). An administrator of the content management system can access content and manage the system via a graphical user interface (GUI) and/or through an application programming interface (API) that is specific to the content management system. Some non-limiting examples of content management systems that manage records associated with documents and/or other content include IBM InfoSphere Enterprise Records, Oracle Universal Records Management, and Microsoft SharePoint Server.

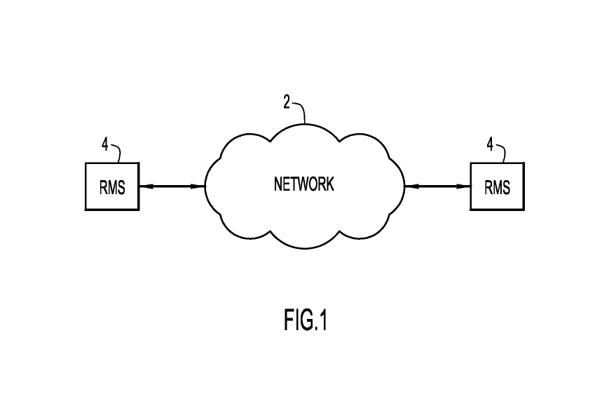

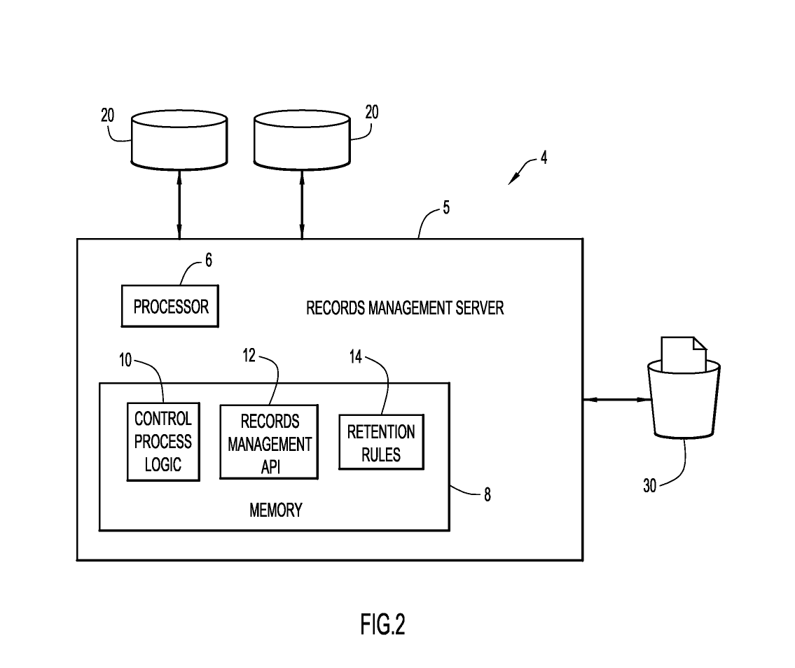

An example computing environment in which a domain-specific language defining retention rules for content can be generated and/or implemented is illustrated in FIGS. 1 and 2. Referring to FIG. 1, a computing environment comprises two or more records management systems 4 (RMS) that store and provide access to content and which are capable of interacting with each other as well as any other systems or computing devices via a network 2. The network 2 can comprise any one or more suitable network configurations that facilitate connection for exchange of data and information between the record management systems 4 as well as other systems and/or computing devices including, without limitation, wide area network (WAN) (e.g., for distant connections), local area network (LAN) (e.g., for local connections), Internet, Intranet, hardwired connections, wireless link connections, etc.

Referring to FIG. 2, an example embodiment of a records management system 4 includes a server 5 that connects with one or more data repositories 20 which store content (e.g., textual content such as any form of written documents, video and/or still images, audio files, as well as any other forms of data) as well as records that are linked with content in order to processing and access to such content (e.g., utilizing records to organize, categorize/classify, store, add/modify/delete content). While only two data repositories 20 are depicted in FIG. 2, it is noted that the records management system 4 can include any suitable number of data repositories depending upon the amount and/or types of content and records being managed by the system 4. The records management server 5 connects with the data repositories 20 to obtain content (e.g., based upon queries for such content) as well as process the content (add/modify/delete content).

The records management server 5 may be implemented by any conventional or other computer system that is equipped with a display or monitor, a base or mainframe including at least one processor 6, a memory 8 and/or internal or external network interface or communications devices (e.g., modem, network cards, etc.) and optional input devices (e.g., a keyboard, mouse, or other input device). The memory for each device can be RAM and/or ROM memory configured as one or more hardware units of each device. The memory 8 of the server 5 includes a control process logic software module 10 including operating system code for the processor 6 as well as any other commercially available and custom software to facilitate operations of the server 5 utilizing the processor 6 in relation to content management system operations as well as those described herein. In particular, the memory 8 includes a records management application programming interface module (API) 12 and a retention rules module 14 that stores rules in the domain-specific language format as described herein. The records management API module 12 provides an interface for accessing and processing records as well as content within repositories 20 (e.g., an interface for facilitating the creation, modification, deletion, organizing/categorizing, etc. of records and content within the repositories). The records for the records management system can contain any suitable information that links the records with corresponding content stored within the repositories, such as metadata that provide information about corresponding content and access link information that links the records to the corresponding content within the repositories.

The retention rules module 14 includes retention rules in a domain-specific language that are to be applied to certain content identified by the retention rules. As described herein, the processor 5, utilizing the control process logic module 10, can generate and/or implement rules in the domain-specific language and further can provide such generated rules to other records management systems for implementation in relation to specified content and retention schedules associated with such other systems. The server 5 is also connected to a dispenser repository 30 for directing content that is to be removed from repositories 20, based upon the retention rule schedule, to the repository 30 for further processing (e.g., destroying, deleting or processing such content in any suitable manner).

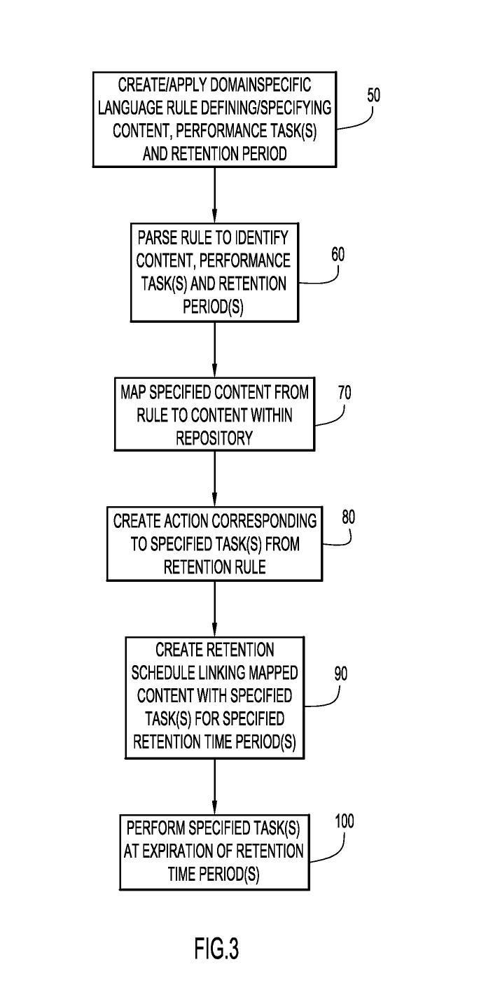

An example embodiment for generating and implementing a retention schedule rule for content utilizing the systems depicted in FIGS. 1 and 2 is now described with reference to the flow chart of FIG. 3. At 50, a retention rule is created in a domain-specific language that identifies specific content subject to the rule, the retention period for such content and a performance task associated with such content. The retention rule can be stored within the retention rules module 14. The domain-specific language can be defined using BNF (Backus Normal Form) grammar or any other suitable grammar format. The retention rule can be created, e.g., by an administrator at the server 5 of a records management system 4 or, alternatively, by an authorized user at a remote computing device (where the remote computing device then provides the rule to the records management system for implementation).

Some example embodiments of a domain-specific language rule that can be created to manage content in an enterprise content management system for a large corporation or other business entity are now described. Any suitable type of language can be utilized that is common or configured for use by one or more database management systems (e.g., SQL In one example, a retention schedule can be selected to eliminate specific content such as email after a specified retention period, such as 3 years. An example embodiment of a domain-specific language rule for this scenario is as follows:

RETAIN(DocumentClass=‘Email’) 3 YEARS THEN DESTROY

The domain-specific rule establishes a specific type of content (email content) for retention, a period of retention (3 years), and also a performance task upon expiration of the retention period (destroy emails after 3 year period). The age or initial date utilized to determine a date of retention would be known for each email based, e.g., on metadata information in the records associated with such emails (e.g., identifying dates in which such emails were received). In this example, the records management system 4 may perform the task automatically (i.e., no human review or action taken to delete or destroy the email content from data sources associated with the system 4).

In a scenario in which an employee leaves the corporation, the rules for the enterprise content management system may require that records and content associated with such employee be retained for a specified time period from the date of separation of the employee from the corporation. An example embodiment of a domain-specific language rule for this scenario is as follows:

RETAIN(Date_Of Separation_Of Employee1 IS NOT NULL) 5 YEARS AFTER Date_Of Separation_Of Employee1 THEN REVIEW

In this rule, the specified content is date of separation associated with an employee with ID Employee1, the retention period is 5 years after this date of separation and the performance task is flagging related records and/or content of this employee for review after the 5 year period has expired. In this example, the records management system 4 may perform an automated task of providing notice to an administrator or other authorized user of the system 4 after the 5 year retention period, where such authorized person then performs the task of reviewing the records and/or content associated with the employee separated from the corporation. Alternatively, a series of specified procedures for handling the separated employee records and content may be performed automatically by the system 4 (e.g., by automatically processing and/or destroying records and content associated with the separated employee in accordance with a specified algorithm).

Other types of rules can also be generated that define multiple performance tasks to be executed based one or more retention dates. For example, a rule could be implemented that builds upon the previously described employee separation rule in which content associated with a separated employee is reviewed at the 5 year date from employee separation, and in which some or all of the content associated with the separated employee is destroyed (e.g., moved to repository 30) at the 10 year date from employee separation (i.e., two different performance tasks implemented at two different retention dates). In addition, retention rules can also be defined that relate to two or more types of content (e.g., retain two or more types of content for a defined retention period and then perform one or more tasks associated with such defined content).

The retention rules can be created or generated at one records management system 4 and then provided to another records management system 4 (e.g., as shown in the embodiment of FIG. 1) for use or implementation by that system based upon the content and the need for establishing a retention schedule in association with that system. For example, a domain-specific language rule establishing a retention schedule of employee records and content can be generated by one records management system 4, where the rule provides a basic definition or “shell” structure for the rule, and this rule is provided to another records management system 4 for implementation in relation to content associated with that system. After receiving and storing the domain-specific language rule in its basic structure within the retention rules module 14, that system 4 can implement the rule by providing a specific retention time period as well as a specific task to be implemented based upon system requirements associated with processing content and records associated with a separated employee. Thus, the rule can be customized to the preferences or requirements of that system.

Implementation of the rule at a records management system 4 can include parsing the language of the rule, via the processor 6, at 60 in order to determine the specified content, the retention period(s) and the performance task(s) associated with the rule. At 70, the specified content from the rule is mapped to content within the data repositories 20 of the system 4. For example, the records management API 12 can identify which content needs to be accessed from repositories 20 based upon the content specified by the rule, and the identified content can be mapped to actions associated with the API 12.

At 80, one or more actions are created within the system 4 that correspond to the performance task or tasks specified by the rule. In particular, actions can be created within the records management API 12 that correspond with the performance task or tasks (e.g., deletion of specified content, such as emails or other categories of documents) to be executed after the specified retention period (e.g., 3 years) has expired.

At 90, a retention schedule is created that links the mapped content with the specified performance task(s) to be executed at the expiration of the specified retention time period. For example, the actions created within the records management API 12 in association with performance tasks and retention time periods can be linked so as to enable performance of one or more tasks upon expiration of the rule defined time period(s).

At 100, upon expiration of a retention time period, the specified task(s) from the rule that have been created as actions (e.g., within the records management API 12) are performed. As previously noted, the performance task(s) can be automatically executed (e.g., deletion of the specified content) or flagged for review by an administrator (e.g., where an automatic notification is sent to the administrator with the task or tasks to be performed at the expiration of the retention time period).

Referring again to the previous example of a retention rule in which employee records and content are retained for a specified time period after the date of separation of the employee from the corporation, a generated domain-specific language rule is generated and stored within the retention rules repository 14 of the system 4. As previously noted, the rule can be generated by one system 4 (or other computing device) and provided to another system 4 for implementation based upon the specific content of that system to be associated with the rule. During implementation of this rule, the server 5 parses the rule to identify the content, retention period(s) and action(s) to be taken. A property can be created entitled “Date_Of_Separation” with the information associated with when an employee has separated from the corporation. A sub-classification in the records classification can also be created using the “Date_Of_Separation” property and also an event associated with this property (Date_Of Separation is NOT NULL). A review action is further created and associated with this property. Finally, a retention schedule is created that links the employee property and the record sub-classification, event and review action associated with this employee property for the specified retention period (e.g., 5 years as set forth in the domain-specific language rule). Upon expiration of the retention period, the review action is performed (e.g., performed automatically by the system 4 or by providing a notice or indication to an administrator to review records and/or content associated with this employee). An action might include removing records and/or content associated with the employee identified by the rule from repositories 20 and to the repository 30 for further processing (e.g., deletion, off-site storage or any other form of processing).

Thus, the embodiments described herein provide a number of beneficial features for generating and implementing a retention schedule for specified content using a rule defined by a domain-specific language. The rule can be generated in a domain-specific language that is configured for implementation within the same or different record management systems and/or other types of content management systems, where one system generates the rule and renders it available for implementation by another system. The system implementing the rule can customize or configure the rule based upon requirements or specifications associated with the system (e.g., specific types of content, retention periods and actions to be taken). In addition, rules can be implemented which utilize a plurality of retention periods and/or implement a plurality of different actions based upon the expiration of such retention periods.

Providing a retention rule for specified content that is implemented via a domain-specific language reduces ambiguities in how to retain certain types of content based upon specific scenarios. Providing retention rules in this manner also allows a more uniform and easy way for administrators to describe actions (based upon a domain-specific language that is usable by different records management and other content management systems), where the records management API can automatically implement actions needed to apply the record retention rules. In addition, any suitable software tool that utilizes a domain-specific language associated with the content management system can be used to implement the retention rules (e.g., rules can be set up remotely by authorized computing systems that communicate with a record management system or other type of content management system).

It will be appreciated that the embodiments described above and illustrated in the drawings represent only a few of the many ways of implementing embodiments for defining content rules using a domain-specific language.

The topology or environment of the present invention embodiments may include any number of computer or other processing systems (e.g., client or end-user systems, server systems, etc.) and search engines, databases, or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any commercially available or custom software (e.g., browser software, communications software, server software, natural language processing software, search engine and web crawling software, etc.). These systems may include any types of monitors and input devices (e.g., keyboard, mouse, voice recognition, touch screen, etc.) to enter and/or view information.

It is to be understood that the software (e.g., the API modules as well as any other software modules associated with operation of the record management system) of the present invention embodiments may be implemented in any desired computer language and could be developed by one of ordinary skill in the computer arts based on the functional descriptions contained in the specification and flow charts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among any one or more types of computing systems, including end-user/client and server systems, and/or any other intermediary processing devices including third party client/server processing devices. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments may be available on a computer useable or recordable medium (e.g., magnetic or optical mediums, magneto-optic mediums, floppy diskettes, CD-ROM, DVD, memory devices, etc.) for use on stand-alone systems or systems connected by a network or other communications medium.

The communication network may be implemented by any number of any types of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number data sources implemented as any conventional or other types of databases, data stores or storage structures (e.g., files, databases, data structures, data or other repositories, etc.) to store documents and related content associated with such documents.

The present invention embodiments may employ any number of any type of user interface (e.g., Application Programming Interface (API), Graphical User Interface (GUI), command-line, prompt, etc.) for communicating between two or more computing devices of the content management system, where the interface(s) may include any information arranged in any fashion. The interface(s) may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method of creating a retention schedule for content within a content repository comprising:
obtaining a rule in a domain-specific language specifying content for retention, a retention time period, and a task for performance upon expiration of the retention time period; and
processing the rule to create the retention schedule, wherein processing the rule includes:
mapping the specified content to content within the content repository;
creating an action corresponding to the specified task for the content repository; and
creating the retention schedule linking the mapped content and created action for the specified retention time period.

2. The computer-implemented method of claim 1, wherein the rule comprises a plurality of tasks for performance upon expiration of one or more retention time periods, a plurality of actions corresponding to the specified tasks are created for the content repository, and the retention schedule is created to link the mapped content and created actions for the at least one specified retention time period.

3. The computer-implemented method of claim 2, wherein a first task and corresponding first action are associated with a first retention time period, and a second task and corresponding second action are associated with a second retention time period.

4. The computer-implemented method of claim 1, further comprising:
generating the rule at a computing device; and
receiving the generated rule at a first records management system, wherein the second records management system processes the rule.

5. The computer-implemented method of claim 4, wherein the computing device comprises a second records management system.

6. The computer-implemented method of claim 4, wherein the obtaining the rule further comprises:
providing at least one of a specific retention time period, specific content and a specific task for performance upon expiration of the retention time period at the first records management system after receiving the generated rule.
